(19) United States
(12) Patent Application Publication
(10) Pub. No.: US 2011/0076451 A1
(43) Pub. Date: Mar. 31, 2011

(54) IMPRINTING METHOD AND DEVICE UTILIZING ULTRASONIC VIBRATIONS

(76) Inventors: Harutaka Mekaru, Ibaraki (JP); Masaharu Takahashi, Ibaraki (JP); Ryutaro Maeda, Ibaraki (JP)

(21) Appl. No.: 12/736,925

(22) PCT Filed: Apr. 1, 2009
(86) PCT No.: PCT/JP2009/056813

§ 371 Date: Nov. 23, 2010

(30) Foreign Application Priority Data
May 26, 2008 (JP) 2008-136383

(51) Int. Cl. B32B 3/00; B29C 59/16

(52) U.S. Cl. 428/141; 425/174.2; 264/443

(57) ABSTRACT

Disclosed is nanoimprint technology that enables the transfer of fine patterns to the surfaces of various molding materials, including general-purpose engineering plastic, in a short manufacturing process time. Embodiments of the present invention include a nanoimprint method for transferring fine patterns of a mold surface to a molding material by pressing the mold against the molding material while applying ultrasonic vibrations that propagate in the direction of application of a load, where the application of the ultrasonic vibrations and the load is started without heating said molding material to glass-transition temperature and, during at least the application of ultrasonic vibrations, said mold is fixed to the application mechanism of said ultrasonic vibrations.

### FIELD OF THE INVENTION

The present invention relates to a nanoimprint method for transferring fine patterns to the surface of a molding material, and specifically relates to a method and apparatus for molding at room temperature.

### BACKGROUND

In manufacturing processes for semiconductor devices and photonic devices, the molding of patterns of sizes ranging from nanometers to several tens of micrometers has primarily been conducted using photolithography or electron-beam lithography to transfer patterns by exposing photosensitive material coated on a substrate. But the conventional technologies involve many steps within the manufacturing process and the use of expensive apparatuses in each step, making these manufacturing technologies highly costly. However, a new technology, a nanoimprint technology, has been proposed in the following non-patent literature 1. Although nanoimprint technology involves the use of semiconductor manufacturing processes for mold production, it is a technology for mass production of duplicates with fine patterns formed through high-resolution molding technology. Compared to the semiconductor manufacturing processes, nanoimprinting involves a simple process for transferring fine patterns, and the cost of imprint apparatuses can be kept low.

Broadly, there are two types of nanoimprint technologies. The one is thermal imprinting, which involves molding by heating and cooling thermoplastic material, and the other is UV imprinting, which involves molding by exposing ultraviolet curable resin to ultraviolet radiation. The thermal imprinting has drawn attention as a technology for manufacturing next-generation storage media, such as Blu-ray discs, and chips for biological and chemical tests. However, one challenge for establishing thermal nanoimprinting as a mass-production technology is the need to shorten the process time. Current storage media, such as CDs and DVDs, are primarily manufactured using injection molding. For the substrate material of such media, polycarbonate (PC), has been widely used because it has high optical transparency and low water absorbency. Currently, the required process time for manufacturing a single PC substrate is approximately 2 seconds. In contrast, the required process time for current thermal imprinting methods is approximately 10 minutes. Consequently, in order for thermal imprinting to become a substitute for injection molding, it is necessary to greatly reduce the process time.

In conventional thermal imprinting, 70% of the total manufacturing process time is spent on thermal cycle processes related to heating and cooling. For such issue, a method for imprinting at room temperature with no thermal cycle processes has been disclosed in the following non-patent literature 2. FIG. 1 corresponds FIG. 5 in non-patent literature 2 and shows an outline of the manufacturing process proposed in non-patent literature 2. According to non-patent literature 2, first, in step (a), a polymer layer is formed on a substrate through spin coating. In step (b), the substrate on which the polymer layer has been formed and a mold (made of silicon) are placed on an apparatus and a vibration generator and a horn are slowly lowered on top of the mold to start applying pressure on the mold. In step (c), the vibration generator generates ultrasonic vibrations. The horn functions to amplify the generated ultrasonic vibrations. In step (d), the ultrasonic vibrations are stopped to wait for the temperature of the mold to decrease. Step (e) shows the demolding process.

As shown clearly in the illustrations of steps (a) and (b), the mold and the mechanism for applying ultrasonic vibrations are separated in the system proposed in non-patent literature 2. Hence the system proposed in this document is one in which, essentially, the back surface of the mold has to be struck repeatedly by an ultrasonic vibrator to dig the mold pattern in the surface of the molding material. According to non-patent literature 2, this method enables to transfer fine patterns to the surface of the mr-I 8030 nanoimprint resist (glass-transition temperature: 115° C.) produced by micro resist technology GmbH.

However, according to studies conducted by the present inventors, it was not possible to perform imprinting on the surface of general-purpose engineering plastic at room temperature using the method disclosed in non-patent literature 2 (please refer to the following non-patent literature 3). When an experiment on imprinting on polycarbonate (glass-transition temperature: 150° C.) was conducted using the method disclosed in non-patent literature 2, as shown in the microscope photographs of FIG. 12 of non-patent literature 3, it was not possible to transfer the pattern unless the polycarbonate was heated almost up to the glass-transition temperature.

In addition to the nanoimprint method disclosed in non-patent literature 2, proposals for applying ultrasonic vibrations during pressing in order to lower the pressing pressure and shorten the pressurization time are described in the following Patent Documents 1 and 2. However, as with the conventional methods, these methods also involve heating the molding material to the glass-transition temperature or higher and do not lead to any shortening of the thermal cycle time.

### PRIOR ART DOCUMENTS

### Non-Patent Literatures

[non-patent literature 1] S. Y. Chou et al., Appl. Phys. Lett vol. 67, p. 3314 (1995)
[non-patent literature 2] C. Lin et al., J. Microlith. Microfab. Microsyst., vol. 5, p. 011003-1 (2006)
[non-patent literature 3] H. Mekaru et al., Jpn. J. Appl. Phys., vol. 46, p. 6355 (2007)

### Patent Documents

[Patent Document 1]U.S. Pat. No. 3,619,863
[Patent Document 2] Japanese unexamined patent publication 2004-288811
[Patent Document 3] Japanese unexamined patent publication 2003-100609

### SUMMARY OF THE INVENTION

### Problems to be Solved by the Invention

Based on these circumstances, the inventors of the present application have worked to develop technology allowing for the transfer of fine patterns to the surfaces of various molding materials, including general-purpose engineering plastic, with a short manufacturing process time.

As a result of dedicated developments, the inventors of the present application have discovered that it is possible to achieve the above object by performing pressing while applying ultrasonic vibrations that propagate in the direction of pressurization while keeping the mold fixed to the mechanism for applying ultrasonic vibrations during nanoimprinting.

### Solutions to the Problems

According to the present invention, by performing pressing while applying ultrasonic vibrations that propagate in the direction of pressurization while keeping the mold fixed to the mechanism for applying ultrasonic vibrations, it is possible to transfer fine patterns to various materials without first heating the molding material to the glass-transition temperature or above. Depending on the molding material, it is even possible to transfer patterns at room temperature.

In order to explain the effect of the present invention, FIG. 2 and FIG. 3 have been attached. FIG. 2 is a copy of FIG. 12 of non-patent literature 3 cited above and shows microscope photographs of the results of experiments in which fine patterns were transferred to polycarbonate (glass-transition temperature: 150° C.) using basically the same method as that of non-patent literature 2. The differences between (a) through (c) are differences in preheating, where the polycarbonate has been heated before pressing to 150° C. in (a), 140° C. in (b), and 130° C. in (c). As is clearly shown in the photographs of FIG. 2, the pattern transfer can be said to have been somewhat successful when the preheating temperature was 150° C. and 140° C., but when the preheating temperature was 130° C., there was absolutely no pattern transfer.

Moreover, in FIG. 2(c), the parts indicated by white circles are fragments of the mold. These indicate that the mold was damaged during the transfer process. In other words, it was discovered that when the molding material is polycarbonate, at a preheating temperature of 130° C., not only is it not possible to transfer the pattern, the mold becomes damaged.

As described above, the system of non-patent literature 2 strikes the back surface of the mold repeatedly with an ultrasonic vibrator to dig the mold pattern in the surface of the molding material. However, based on the photograph of FIG. 2(c), it is believed that if the polycarbonate is not heated to near the glass-transition temperature, the mold is unable to withstand the impact when it is struck against the polycarbonate and becomes damaged because the polycarbonate lacks flexibility and remains hard. It should be noted that the mold used for the experiment of FIG. 2 was made of silicon and was manufactured using the same material as the mold used in non-patent literature 2.

In comparison, FIG. 3 shows microscope photographs depicting the results of imprint tests conducted using a method based on the proposal of the inventors of the present application. For this test, the apparatuses shown in FIG. 5 were used (details of the apparatuses shown in FIG. 5 will be described later). The frequency and amplitude of the applied ultrasonic vibrations were 10 kHz and ±3 μm, respectively, and the load was 100 N and the molding time was 10 seconds. Moreover, a cooling device was operated at 25° C. to cool the molding material from the other side of the surface being molded. Cooling was also performed during pressing. In FIG. 3, (a) is a microscope photograph of the mold used in the experiment, and (b) through (f) are microscope photographs of the results of imprinting on various molding materials, showing the results of imprint tests on polyethylene terephthalate (glass-transition temperature: 75° C.), polycarbonate (glass-transition temperature: 150° C.), polymethyl methacrylate (glass-transition temperature: 105° C.), cyclo-olefin polymer (glass-transition temperature: 138° C.), and polyimide (glass-transition temperature: 300° C. or more), respectively.

As is clearly shown in FIG. 3(c), the pattern transfer to polycarbonate at the glass-transition temperature or below, which was not possible using the method of non-patent literature 2, became possible using the method based on the proposal of the inventors of the present application. Moreover, as is shown in (d) through (f), according to the method based on the proposal of the inventors of the present application, pattern transfers to various materials were successful. These results demonstrate that the method based on the idea of the inventors of the present application is applicable to a wide range of materials.

What is particularly notable about the tests of FIG. 3 is that the molding material is being cooled during pressing. In normal thermal nanoimprinting, it is necessary to heat the molding material to maintain the glass-transition temperature or higher during pressing. In contrast, actual embodiments of the present invention include those that cool the molding material during pressing.

The fact that the molding material can be maintained at a low temperature during pressing means that the cooling time after the pressing process can be dramatically reduced or eliminated, and this provides the advantage of shortening the total process time. At the same time, another important advantage is that thermal damage to the molding material can be reduced. In particular, for nanoimprinting for producing multilayer structures, it is important to perform molding at as low a temperature as possible in order to reduce thermal damage to the lower layers. The present invention makes it possible to perform imprinting on various materials at low temperatures (in some cases, at room temperature), and is thus capable of providing solutions for cases of imprinting in which a low temperature is required.

FIG. 4 illustrates the fundamental differences between the imprint system described in non-patent literature 2 and the imprint system based on the proposal of the inventors of the present application. In the system described in non-patent literature 2 (FIG. 4(a)), S11 illustrates the preparation process for starting imprinting, where it should be noted that neither the horn nor the mold are fixed (furthermore, the horn is part of the mechanism for applying ultrasonic vibrations and functions to amplify vibrations generated by the vibration generator). In S12 and S13, pressing is performed and ultrasonic vibrations are applied, but because the mold is not fixed to the horn at this time, the pressure of the horn applied to the mold changes regularly (e.g., in the example of FIG. 4, the mold is compressed by the horn in S12, but in S13, the mold does not receive any pressure from the horn). In other words, the horn can be more accurately described as repeatedly striking the back surface of the mold at a high speed, rather than saying as pressing against the mold.

In comparison, the method based on the proposal of the inventors of the present application (FIG. 4(b)) involves pressing and the application of ultrasonic vibrations while the mold is fixed to the mechanism for applying ultrasonic vibrations. S21 illustrates the preparation process for starting imprinting and is a process corresponding to S11 of the conventional technology, but in this case, the mold is already fixed to the horn. Therefore, during the processes of pressing and applying ultrasonic vibrations (S22, S23), the mold vibrates up and down rapidly in concert with the rapid vibration of the horn. Then, the sidewall parts of the fine patterns of the mold rub against the sidewalls of the mold pattern that has been finely formed by the press load, frictional heat is generated between them. This frictional heat softens the molding material locally. And the softened molding material can intrude into the fine concave structures of the mold by the press load.

### EFFECTS OF THE INVENTION

In contrast to the imprint method of non-patent literature 2, which performs pattern transfer by “hammering” the mold onto the molding material, the imprint method according to the proposal of the present inventors performs pattern transfer by locally softening the molding material through “frictional heat” to inject the material into the fine concave structures. Therefore, the principles for enabling pattern transfer of the present invention differ from those used in the imprint method of non-patent literature 2. This difference in principles makes it possible to greatly shorten or omit the thermal cycle processes that have required large amounts of time in conventional thermal imprinting processes, and furthermore, this makes it possible to perform imprinting on a wider range of materials compared to the method described in non-patent literature 2.

### BRIEF DESCRIPTION OF THE DRAWINGS

FIG. 1 illustrates an outline of a nanoimprint process according to the prior art (non-patent literature 2)

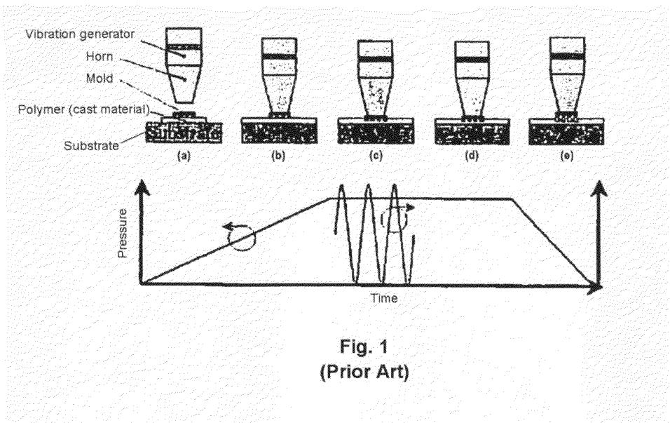

FIG. 2 shows the results of nanoimprint tests conducted on polycarbonate according to the prior art (non-patent literature 2) (microscope photographs)

FIG. 3 shows the results of nanoimprint tests conducted on polycarbonate, etc. according to an embodiment of the present invention (microscope photographs)

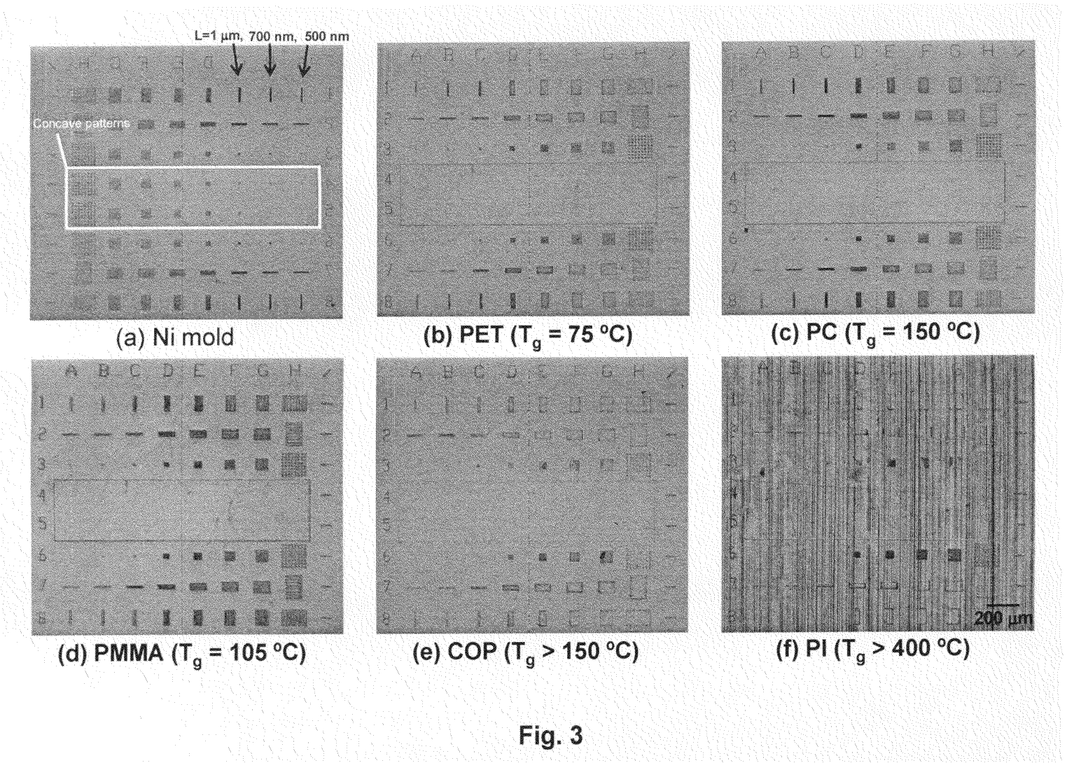

FIG. 4 is an explanatory diagram of differences in the nanoimprint systems of the prior art (non-patent literature 2) and the present invention

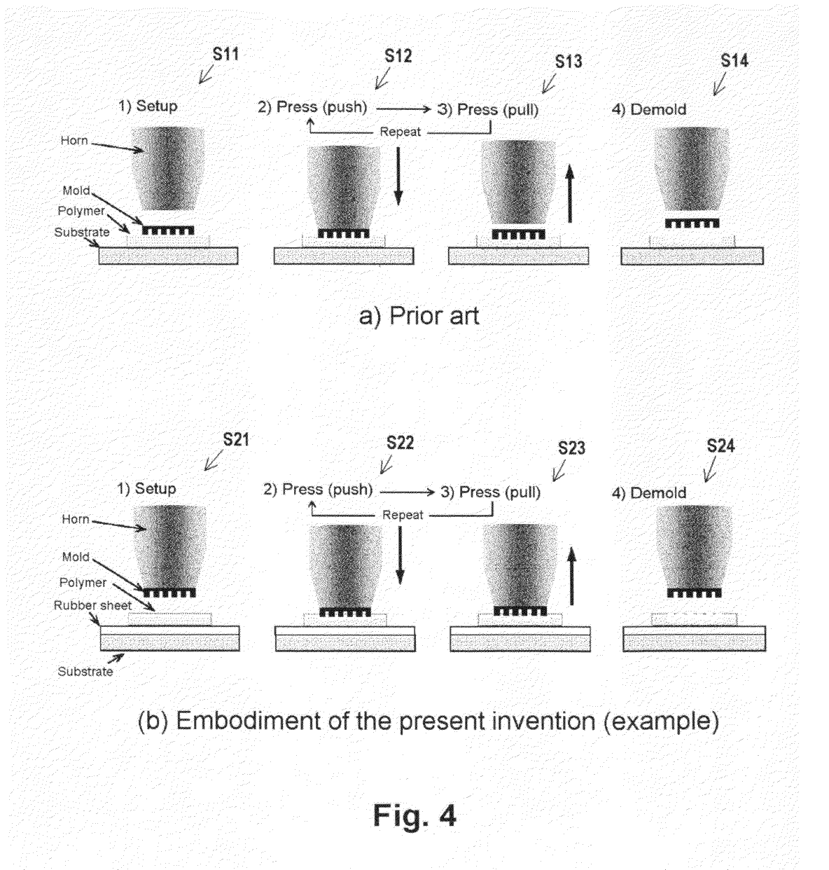

FIG. 5 is a cross-sectional diagram of the principal parts of an imprint apparatus 500 that is an embodiment of the present invention

FIG. 6 is an explanatory diagram of the operations of the imprint apparatus 500

FIG. 7 is a diagram showing the results of Test 1 (differences in mold pattern depth according to the use or non-use of ultrasonic vibrations)

FIG. 8 is a diagram showing the results of Test 1 (SEM photographs of the pattern of an electroformed NI mold as well as fine patterns transferred to a polyethylene terephthalate surface)

FIG. 9 is a diagram showing the results of Test 2 (showing differences in mold pattern depth according to the frequency of ultrasonic vibrations)

FIG. 10 is a diagram showing the results of Test 3 (showing differences in mold pattern depth according to the amplitude of ultrasonic vibrations)

FIG. 11 is a diagram showing the results of Test 4 (showing differences in mold pattern depth according to the hardness of the buffer material)

FIG. 12 is a diagram showing the results of Test 5 (SEM photographs of fine patterns transferred to polycarbonate and polymethyl methacrylate

FIG. 13 is a diagram showing the results of Test 6 (SEM photographs of fine patterns transferred to a spin-on glass surface)

### DESCRIPTION OF EMBODIMENTS

Embodiments of the present invention include a nanoimprint apparatus configured to transfer fine patterns of a mold surface to a molding material by pressing said mold against said molding material or pressing said molding material against said mold while applying ultrasonic vibrations that propagate in the direction of application of a load, where said nanoimprint apparatus is configured to start an application of said ultrasonic vibrations and said load without heating said molding material to glass-transition temperature, and a mechanism for applying said ultrasonic vibrations comprises a part for fixing said mold during at least the application of said ultrasonic vibrations.

The above-mentioned nanoimprint apparatus may comprise a thermoregulator for cooling the molding material during the application of ultrasonic vibrations. This thermoregulator is operable to maintain a temperature of at least part of the molding material during the application of ultrasonic vibrations.

The above-mentioned nanoimprint apparatus may be configured to be capable of changing at least one of the amplitude and frequency of the ultrasonic vibrations. Further, the above-mentioned nanoimprint apparatus may be configured to be capable of causing at least one of the amplitude and frequency of the ultrasonic vibrations to become non-uniform within the surface on which pressing is being performed by using a plurality of ultrasonic vibration elements capable of changing at least one of the amplitude and frequency, and by operating at least one of these ultrasonic vibration elements at a different amplitude and/or frequency from the other elements.

Embodiments of the present invention include nanoimprint methods such as the following. This method is a nanoimprint method for transferring fine patterns of a mold surface to a molding material by pressing said mold against said molding material or pressing said molding material against said mold while applying ultrasonic vibrations that propagate in the direction of application of a load, comprising: starting an application of said ultrasonic vibrations and said load without heating said molding material to glass-transition temperature, and during at least the application of said ultrasonic vibrations, fixing said mold to a mechanism for applying said ultrasonic vibrations.

In the above-mentioned method, the molding material may be cooled (preferably to room temperature) for at least a certain period during the application of ultrasonic vibrations. Moreover, the molding material may be fixed with a buffer material during at least the application of ultrasonic vibrations.

Embodiments of the present invention include molded products manufactured through the above method.

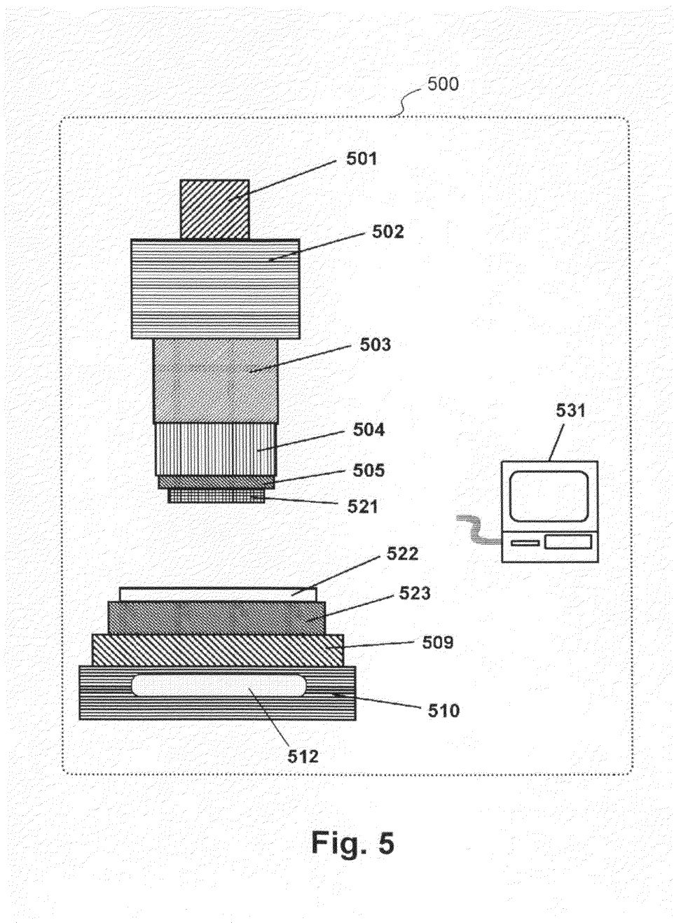

Further examples of embodiments of the present invention will now be described with reference to the attached drawings. FIG. 5 is a cross-sectional diagram of the principal parts of an imprint apparatus 500 that can be regarded as an embodiment of the present invention. The imprint apparatus 500 is divided as an upper part and a lower part, and a mold is fixed to the top part and a molding material is fixed to the lower part. A mold 521 is fixed to a mold-fixing unit 505 by physical or chemical means. Examples of physical means include a vacuum chuck, an electrostatic chuck, or a screw mechanism, and examples of chemical means include adhesive agents. At the same time, a molding material 522 is fixed on a fixing apparatus 509 together with a buffer material 523. The fixing apparatus 509 is also configured to fix the molding material 522 and the buffer material 523 using means such as a vacuum chuck. The buffer material 523 is a member for flattening the pressure distribution in plane during imprinting by alleviating the partial contact of the mold pattern surface and the molding material surface.

An upper stage 504 acts as a frame for supporting an upper structure, and furthermore, it is attached to a lifting and lowering apparatus that is not shown in the diagram and is capable of moving up and down together with the entire upper structure. An ultrasonic vibration generator 503 is installed on the upper part of the upper stage 504, and a pressurizer 502 is installed on a further upper part. An upper-stage leveling apparatus 501 performs positional adjustments so that the upper stage 504 becomes parallel to a lower stage 510. The lower stage 510 includes a thermoregulator 512 for adjusting the temperature of the molding material 522. The thermoregulator 512 may be used for cooling the molding material 522 from the lower surface during pressing, for example. Moreover, on the other hand, it may also be used for heating the molding material 522.

The upper-stage leveling apparatus 501, the stage pressurizer 502, the ultrasonic vibration generator 503, the lifting and lowering mechanism of the upper stage 504, and the thermoregulator 512 are connected to a controller 531 and undergo various kinds of control by the controller 531. The controller 531 can, for example, adjust the applied pressure of the stage pressurizer 502 or adjust the frequency and/or amplitude of the ultrasonic vibrations applied by the ultrasonic vibration generator 503. As an ultrasonic vibration generator capable of providing variable frequencies and amplitudes, a magnetostrictive actuator, for example, may be employed. The magnetostrictive actuator manufactured by ETREMA and used during data collection for the test cases described later is capable of generating ultrasonic vibrations that are direct current (DC) or have frequencies of up to 30 kHZ and amplitude equal to the maximum displacement ±5 μm.

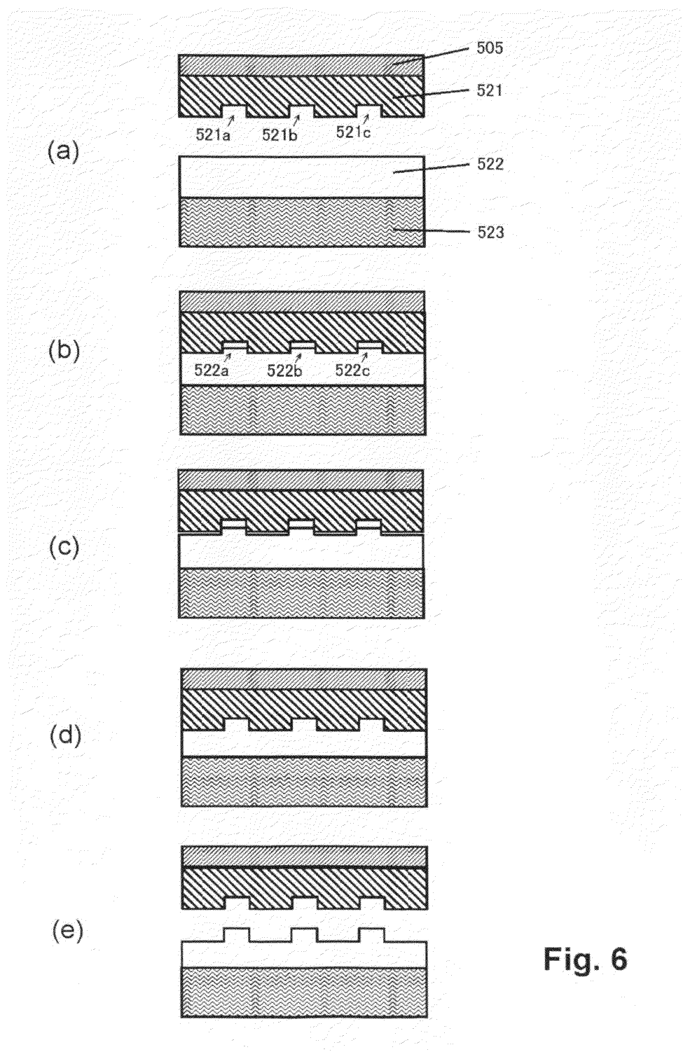

Next, operations of the imprint apparatus 500 will be described with reference to FIG. 6. In FIG. 6, (a) shows a preliminary step for starting imprinting. The mold 521 should be produced in advance, by forming fine patterns 521a-521c on the surface of a silicon substrate or an electroformed Ni substrate, etc. And the molding material 522 is prepared by forming a resin film on a resin substrate or a substrate. As illustrated in FIG. 5, the mold 521 is physically or chemically fixed to the mold-fixing unit 505, and the molding material 522 is fixed to the fixing apparatus 509 with the sandwiched the buffer material 523. The arrangement is such that the fine patterns 521a-521c of the mold 521 face the surface of the molding material 522.

In (b), the upper stage 504 is lowered down, and the mold 521 is placed in contact with the molding material 522. And the controller 531 starts up the pressurizer 502 to apply a load onto the mold 521 and the molding material 522. In the immediate period after starting the application of the load, the surface of the molding material 522 is not yet warm and is therefore hard and cannot be transformed very much. However, even in this case, as indicated by the symbols 522a-522c, a slight level of transformation may be generated.

In (b), the controller 531 starts up the ultrasonic vibration generator 503 while keeping the pressurizer 502 being worked. The temperature of the molding material 522, including the surface thereof, at the startup phase of the pressurizer 502 and the ultrasonic vibration generator 503 is equal to or less than the glass-transition temperature. The ultrasonic vibrations produced by the ultrasonic vibration generator 503 propagate toward the pressurized surface via the upper stage 504 and the mold-fixing unit 505. In other words, the ultrasonic vibrations propagate in the direction of application of the load. As a result of these ultrasonic vibrations, the mold 521 vibrates at a high speed between a state of being pressed firmly against the molding material 522 as illustrated in (b) and a state of being slightly separated from the molding material 522 (or a state in which the load is slightly reduced) as illustrated in (c). As a result, the sidewalls of the concaves 521a-521c of the fine structures of the surface of the mold 521 rub against the sidewalls of embossed parts 522a-522c that have been transformed on the surface of the molding material 522, thus generating frictional heat.

The generated frictional heat locally softens the surface of the molding material 522. Because the flexibility of the softened parts increases, the degree of transformation caused by the press also increases, and the surface members of the molding material 522 are intruded into the concave parts 521a-521c of the fine structures. This is illustrated in (d). Furthermore, in (d), although the illustration shows that the surface members of the molding material 522 are completely intruded into the concave parts 521a-521c, depending on the conditions, it is, of course, possible that the surface members do not transform up to be completely intruded.

In (e), the illustration shows a state in which the application of the load and the ultrasonic vibrations has been stopped, and the mold 521 has been demolded from the molding material 522.

In some embodiments, in the processes (b) through (d), it is possible to operate the thermoregulator 512 to continue cooling the molding material 522 from the side of the lower stage 510. In other words, in the processes (b) through (d), although the surface undergoing pattern transfer increases in temperature and softens due to friction with the fine patterns of the mold 521, in other parts, temperature increases are prevented by the thermoregulator 512. Consequently, when the application of the load and the ultrasonic vibrations is stopped, the molding surface of the molding material 522 rapidly cools and hardens and can be removed from the fixing apparatus 509.

It is a notable feature that the molding material is cooled during pressing. In conventional nanoimprint apparatuses, during pressing, the molding material is heated to maintain a temperature around 30° C. above the glass-transition temperature, and the act of cooling the molding material during pressing completely contradicts conventional practice.

Next, in order to promote a deeper understanding of the present invention, several experiments conducted using the imprint apparatus 500 described above will be presented.

### Experiment 1

### Effects of Applying Ultrasonic Vibrations During Imprint Molding on Polyethylene Terephthalate (PET)

First, in order to observe the effects of applying ultrasonic vibrations during imprint molding, an experiment was conducted under the following conditions.

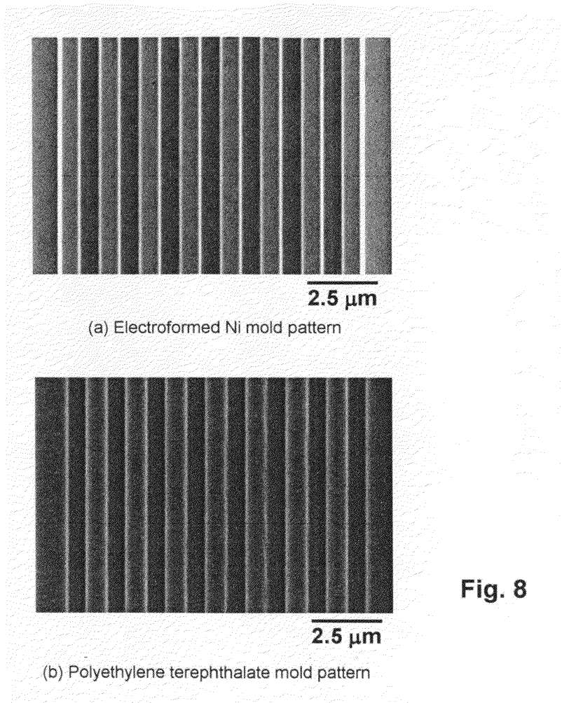

(1) For the ultrasonic vibration generator 503 (refer to FIG. 5), a magnetostrictive actuator manufactured by ETREMA was used. This magnetostrictive actuator is capable of generating ultrasonic vibrations that are direct current (DC) or have frequencies of up to 30 kHZ and an amplitude equal to the maximum displacement ±5 μm.
(2) Using the ultraviolet curable resin PAK-01 manufactured by Toyo Gosei as an adhesive agent, a 15-mm² electroformed Ni standard mold (mold 521) manufactured by SCIVAX was arranged on the mold-fixing unit 505 of the upper stage with a quartz plate interposed in between. By irradiating ultraviolet rays from the side surface of the quartz plate, the PAK-01 underwent ultraviolet curing and the mold was fixed. The width and height of the mold pattern were both 1 μm. Furthermore, scanning electron microscope (SEM) photographs of the mold pattern are shown in FIG. 8(a).
(3) For the molding material 522, a polyethylene terephthalate plate (glass-transition temperature: 75° C.) with a thickness of 0.5 mm was used. This was fixed to the lower stage 510 using a vacuum chuck (fixing apparatus 509) with the sandwiched urethane rubber (buffer material 523) with a thickness of 3 mm. Through-holes for the vacuum chuck were made in the urethane rubber plate.
(4) The fine patterns of the electroformed Ni mold were pressed onto the polyethylene terephthalate surface with a load of 50 N to 1 kN.
(5) When the load reached the set value, the application of ultrasonic vibrations with a frequency of 10 kHz and an amplitude of ±3 μm was started.
(6) During the application of the load and the ultrasonic vibrations, the thermoregulator 512 was operated at a set temperature of 25° C.
(7) After continuing the application of the load and the ultrasonic vibrations for 10 to 90 seconds, the electroformed Ni mold was demolded from the polyethylene terephthalate.
(8) As a comparative example, imprinting was also performed by applying only the load and not applying the ultrasonic vibrations.
(9) In both cases, imprinting was attempted under multiple conditions with different molding loads and molding times.

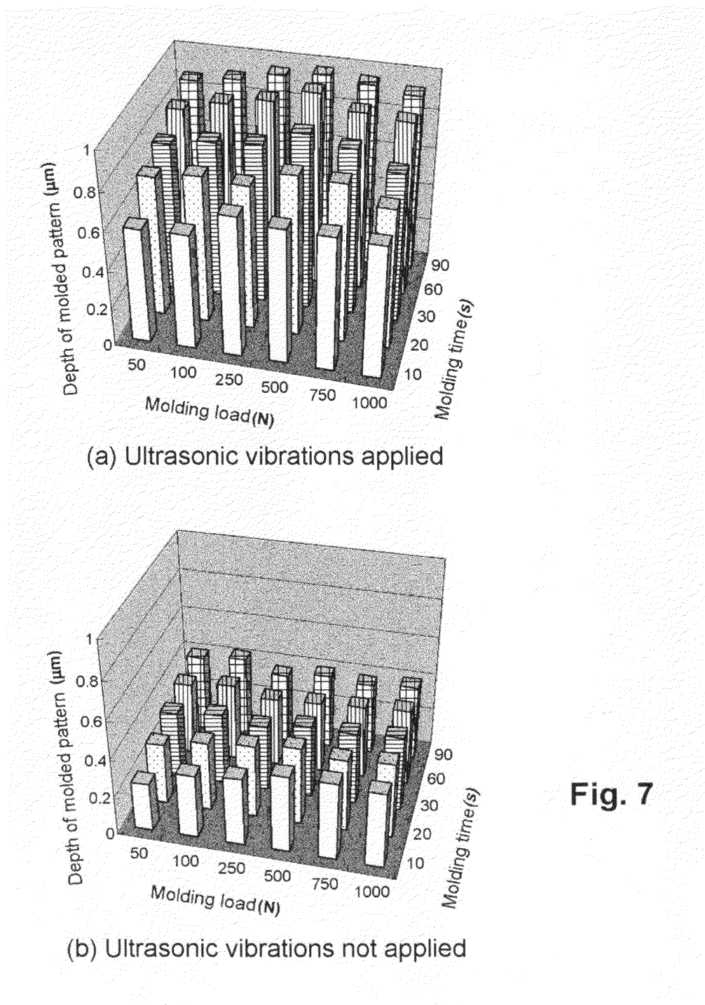

The experiment results are shown in FIG. 7 and FIG. 8. FIG. 7 is a graph prepared based on confocal microscope observations of the depth of the fine patterns transferred to the polyethylene terephthalate surface, where (a) shows a case in which ultrasonic vibrations were applied and (b) shows a case in which ultrasonic vibrations were not applied.

As is clear from a comparison of FIG. 7(a) and (b), it is easily recognizable that a deeper molded pattern was obtained when ultrasonic vibrations were applied. As described above, the height of the mold pattern was 1 μm, and when ultrasonic vibrations were applied, under conditions of a load of 500 N and a molding time of 60 seconds, the depth of the transferred pattern also reached 1 μm, successfully providing a complete mold of polyethylene terephthalate. In comparison, when ultrasonic vibrations were not applied, regardless of the molding load or the molding time, the pattern depth decreased to 0.4 μm or less, and completely molded patterns were not observed. According to the graph of FIG. 7(b), polyethylene terephthalate can be transformed to a certain degree through pressing alone even at room temperature, but it is shown that in order to more accurately transfer the mold pattern, it is clearly effective to apply ultrasonic vibrations. At the very least, it was observed that the use of ultrasonic vibrations is effective when performing imprinting with an aspect ratio (pattern depth/pattern width) of 1 or more.

Based on observations of FIG. 7(a), the depth of the molded pattern became deeper as the molding time was extended, but regarding molding load, the pattern was transferred most deeply under conditions in which the molding load was 500 N. It was believed that this is because an excessively large load constrains the amplitude of the ultrasonic vibrations, making it difficult for the effects of the use of ultrasonic vibrations to become apparent. As described above, the pattern depth reached 1 μm at a load of 500 N and a molding time of 60 seconds or more, successfully providing complete molds of polyethylene terephthalate. The obtained molded patterns were observed using an SEM and the results are shown in FIG. 8(b). In comparison, FIG. 8(a) shows SEM photographs of the patterns of an electroformed Ni mold. A line/space pattern with a pattern width of 1 μm was observed, and it was observed that the edge parts of the fine patterns were also clear.

### Experiment 2

### Effects of the Frequency of Ultrasonic Vibrations on the Imprinting Process

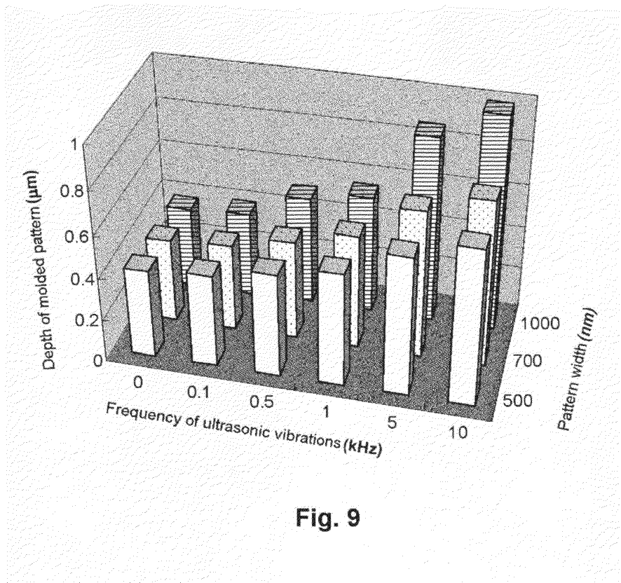

As in Experiment 1, polyethylene terephthalate was used as the molding material, and the frequency of the ultrasonic vibrations applied during the imprinting processes was changed in a phased manner from 0 kHz to 10 kHz, and the depths of the molded patterns were measured. As in Experiment 1, the depths of the molded patterns were measured using a confocal microscope. The maximum amplitude of the ultrasonic vibrations was set to 3 μm. Moreover, the width of the mold pattern was changed to 500 nm, 700 nm, and 1 μm to conduct the measurements. The results are shown in FIG. 9.

Looking at FIG. 9, the depth of the molded pattern became deeper as the frequency of the ultrasonic vibrations became higher, and this trend was more strongly apparent when the pattern width was greater. In particular, when ultrasonic vibrations with a frequency of 5 kHz or more were applied, the depth of the molded pattern was measured at 0.8 μm or more, and the effects of applying ultrasonic vibrations during imprinting were observed to a notable degree.

In this way, because it is predicted that the optimum frequency for the ultrasonic vibrations will differ depending on the pattern width and the aspect ratio, in the embodiments of the present invention, it is preferable to use an ultrasonic-vibration generating mechanism capable of adjusting the frequency. Moreover, because it is believed that the pattern width and the aspect ratio will often differ depending on location in the surface undergoing pattern transfer as well, it is preferable to have a configuration in which the frequency of the ultrasonic vibrations can be changed depending on the location of the surface undergoing pattern transfer. Such embodiments can be realized by, for example, using multiple magnetostrictive actuators and vibrating each at different frequencies.

### Experiment 3

### Effects of the Amplitude of Ultrasonic Vibrations on the Imprinting Process

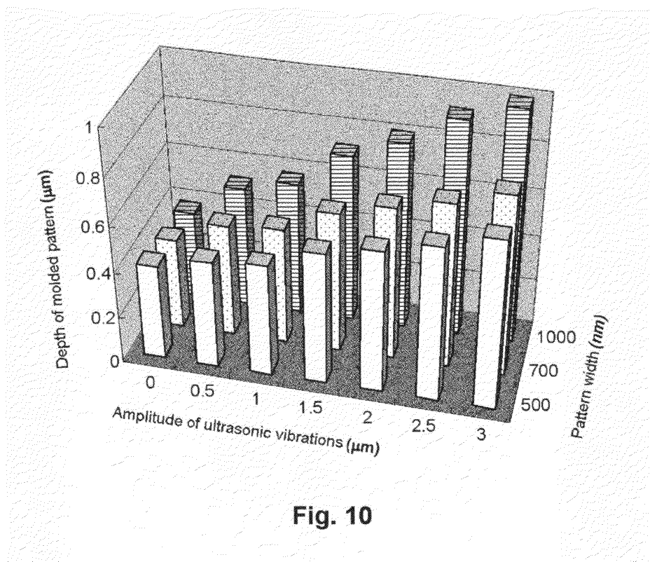

As in Experiment 1, polyethylene terephthalate was used, and the maximum amplitude of the ultrasonic vibrations applied during the imprinting processes was changed in a phased manner from 0 μm to 3 μm, and the depths of the molded patterns were measured. As in Experiment 1, the depths of the molded patterns were measured using a confocal microscope. The frequency of the ultrasonic vibrations was set to 10 kHz. As in Experiment 2, the width of the mold pattern was changed to 500 nm, 700 nm, and 1 μm to perform imprinting. The results are shown in FIG. 10. As shown in FIG. 10, as the amplitude of the ultrasonic vibrations increased, the depth of the molded pattern tended to become deeper. The greater the pattern width, the more apparent were the effects accompanying the changes in amplitude. In particular, when ultrasonic vibrations with an amplitude of 2 μm or more were applied, the depth of the molded pattern was measured as being 0.8 μm or more, and the effects of using ultrasonic vibrations during imprinting were observed to a notable degree.

Based on the results of FIG. 10, as with frequency, it is predicted that the optimum amplitude of the ultrasonic vibrations also differs depending on the pattern width and the aspect ratio. Therefore, in the embodiments of the present invention, it is preferable to use an ultrasonic-vibration generating mechanism capable of adjusting the amplitude in addition to the frequency. Moreover, because it is believed that the pattern width and the aspect ratio will often differ depending on location in the surface undergoing pattern transfer as well, it is preferable to have a configuration in which the amplitude of the ultrasonic vibrations can be changed depending on the location of the surface undergoing pattern transfer. As described earlier, such embodiments can be realized by, for example, using multiple magnetostrictive actuators and vibrating each at different frequencies.

### Experiment 4

### Effects of the Hardness of the Buffer Material on the Imprinting Process

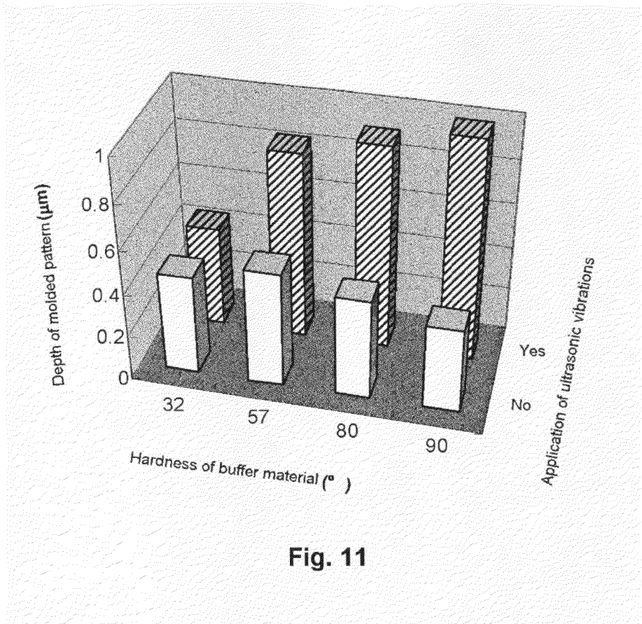

As in Experiment 1, polyethylene terephthalate was used, and the depths of molded patterns with a pattern width of 1 μm were measured in cases using 4 types of buffer material, including urethane rubber (hardness: 90°), fluorocarbon rubber (hardness: 80°), and low-repulsion rubber (hardness: 32° and 57°). As in Embodiment 1, the depths of the molded patterns were measured using a confocal microscope. The frequency of the ultrasonic vibrations and the maximum amplitude were fixed at 10 kHz and 3 μm, respectively. FIG. 11 shows a comparison of the results of cases in which ultrasonic vibrations were applied during the imprinting processes and cases in which ultrasonic vibrations were not applied. In the cases in which ultrasonic vibrations were not applied (i.e., cases of molding using only pressing), the molded pattern was deepest when low-repulsion rubber with a hardness of 57° was used. However, with all of the buffer materials, molded patterns with only a depth of 0.6 μm or less were obtained, and the effects of inserting the buffer material were not apparent. On the other hand, in the cases in which ultrasonic vibrations were applied during the imprinting processes, when urethane rubber, which had the highest degree of hardness, was used, a complete mold with a depth of 1 μm was obtained. For the imprint method using ultrasonic vibrations, it is more effective to insert a buffer material with a relatively high degree of hardness.

### Experiment 5

### Effects of Using Ultrasonic Vibrations on Imprint Molding on Polycarbonate (PC)

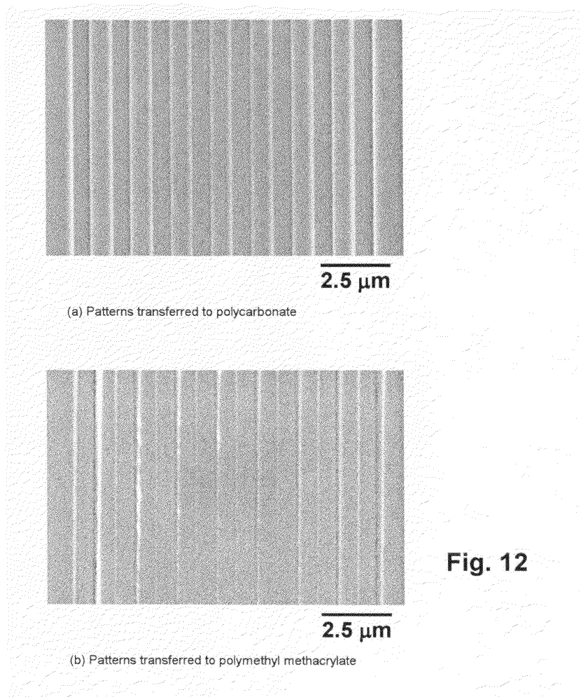

Using the imprint apparatus 500, the molding material was changed to polycarbonate (glass-transition temperature: 150° C.) to conduct the imprinting experiments. As in Experiment 1, for each of the molding conditions, the frequency of the ultrasonic vibrations was set to 10 kHz, the maximum amplitude to 3 μm, the molding load to 500 N, and the molding time to 60 seconds. For the buffer material, a urethane rubber plate was used. The molded patterns were observed using a scanning electron microscope (SEM). FIG. 12(a) shows SEM photographs of line/space patterns with a pattern width of 1 μm.

As with the polyethylene terephthalate of Experiment 1, the formation of fine patterns was observed on the polycarbonate surface. As in Experiment 2, when the depths of the molded patterns with a pattern width of 1 μm were measured using a confocal microscope, the depth was 370 nm. Because the molding conditions had been optimized for polyethylene terephthalate, the depth of the molded pattern was lower compared to the results for polyethylene terephthalate, but it is believed that deeper patterns can be molded by optimizing the molding time, the molding load, and the amplitude and frequency of the ultrasonic vibrations.

As disclosed in the above non-patent literature 3, when polycarbonate is molded through thermal imprinting with a heating temperature of 180° C. and a cooling temperature of 130° C., the thickness of the polycarbonate plate is reduced from 0.5 mm before molding to 0.27 mm after molding. This is due more to the fact that the thermally softened resin flows outward relative to the mold than to the fact that the resin fills the interior of the fine concave structures of the mold. However, in Experiment 5, the plate thickness hardly changed after molding compared to before molding and was measured to be 0.49 mm or more. Consequently, the imprint method of the present invention can be said to be an effective means for preventing the thermal transformation of foundational substrates and lower structures during the imprinting processes.

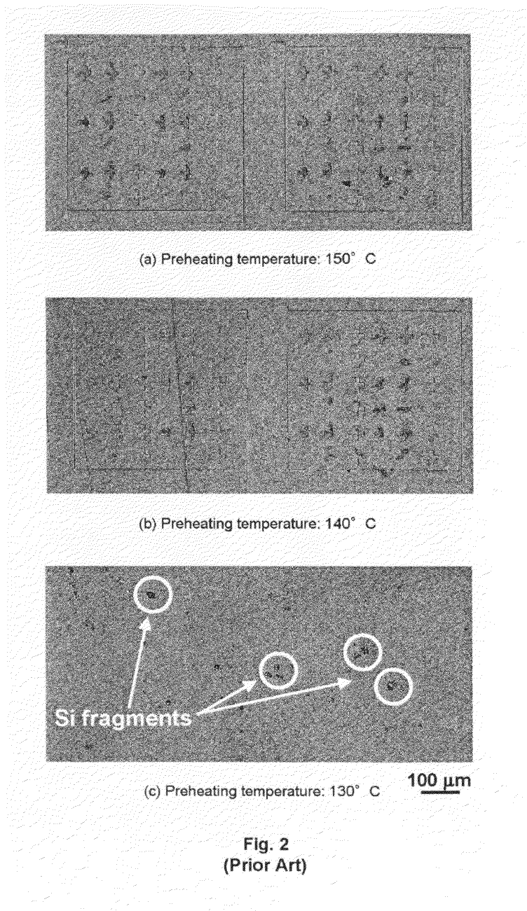

For the purpose of comparison, while keeping the other conditions unchanged, polycarbonate imprinting was conducted using only a press load and without applying ultrasonic vibrations, and the imprint surface was observed using an optical microscope. As a result, traces of contact with the outer frame of the mold pattern were observed, but transfer patterns of the fine patterns of the mold were not observed. Moreover, as shown in FIG. 2, even with the method according to non-patent literature 2, unless the heating temperature was set to 140° C. or more, it was not possible to transfer patterns onto the polycarbonate. In fact, the present invention is the first technology in the world that makes it possible to imprint and transfer fine patterns onto a polycarbonate surface at room temperature.

### Experiment 6

### Effects of Using Ultrasonic Vibrations on Imprint Molding on Polymethyl Methacrylate (PMMA)

Using the imprint apparatus 500, an imprinting experiment was conducted on polymethyl methacrylate (glass-transition temperature: 105° C.). As in Experiment 1, for each of the molding conditions, the frequency of the ultrasonic vibrations was set to 10 kHz, the maximum amplitude to 3 μm, the molding load to 500 N, and the molding time to 60 seconds. For the buffer material, a urethane rubber plate was used. As in Embodiment 6, the molded patterns were observed using a scanning electron microscope (SEM). FIG. 12(b) shows SEM photographs of line/space patterns with a pattern width of 1 μm.

As with the polyethylene terephthalate of Experiment 1 and the polycarbonate of Experiment 5, it was observed that fine patterns were formed on the polymethyl methacrylate substrate. When the depth of the molded pattern with a pattern width of 1 μm was measured using a confocal microscope as in Experiment 2, the depth was 750 mm.

For the purpose of comparison, while keeping the other conditions unchanged, imprinting was conducted on a PMMA substrate using only a press load and without applying ultrasonic vibrations, and the imprint surface was observed using an optical microscope. As a result, as in the cases using polycarbonate, transfer patterns of the mold structures were not observed.

### Experiment 7

### Effects of Using Ultrasonic Vibrations in Imprint Molding on a Spin-on Glass (SOG) Substrate

Spin-on glass refers to a material that is coated on a substrate through spin coating and is heat-treated to form a glass film. In Experiment 7, for the spin-on glass, high-methylsiloxane SOG (Accuglass 512B, manufactured by Honeywell, U.S.A.) and a glass film was formed on an Si substrate to produce a spin-on glass substrate, and an imprinting experiment was conducted on this glass material.

For this experiment, 2 types of substrate were prepared. Generally, the firing of SOG film requires 2-stage heating treatment using a low temperature and a high temperature, but the first substrate was produced by first coating said SOG on the Si substrate at a thickness of 760 nm through spin coating before heating up to 150° C. using a hot plate for 1 minute only. The second substrate was produced by further heating a substrate produced in the same manner as the first substrate for 1 hour to 450° C. using a rapid heat-treatment apparatus (AS-One100 manufactured by AnnealSys, France) and firing the SOG film.

For the imprint apparatus, an apparatus equivalent to the imprint apparatus 500 was used. As in Experiment 1, for each of the molding conditions, the frequency of the ultrasonic vibrations was set to 10 kHz, the maximum amplitude to 3 μm, the molding load to 500 N, and the molding time to 60 seconds. Moreover, the set temperature of the thermoregulator 512 was set to room temperature (25° C.). For the buffer material, a urethane rubber plate was used.

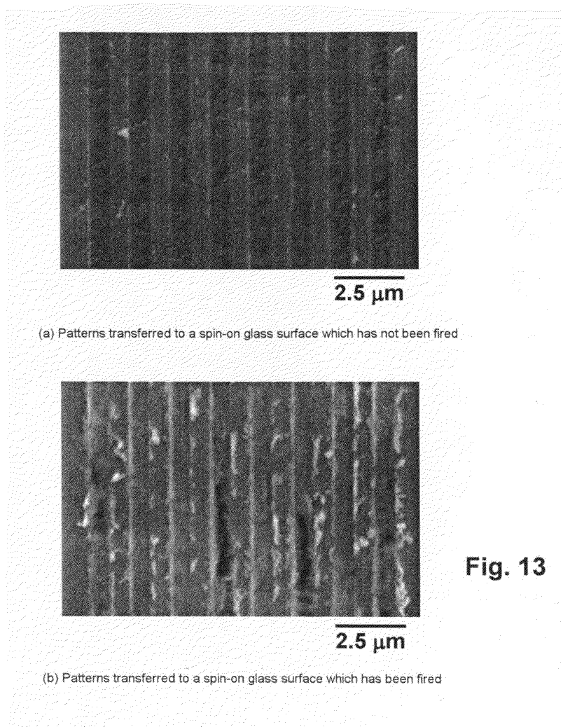

As with Embodiment 6, the molded patterns of both the first and second substrates described above were observed using a scanning electron microscope (SEM). FIG. 13 shows SEM photographs of line/space patterns with a pattern width of 1 μm, where (a) shows the results of imprinting on the first substrate and (b) shows the results of imprinting on the second substrate.

As with the polyethylene terephthalate of Experiment 1, the polycarbonate of Experiment 5, and the polymethyl methacrylate of Experiment 6, it was observed that fine patterns had been formed on the spin-on glass substrate. As in Experiment 2, the depths of the molded patterns with a pattern width of 1 μm were measured using a confocal microscope, and the depth was 300 nm for the first substrate and 210 nm for the second substrate.

For the purpose of comparison, while keeping the other conditions unchanged, imprinting was conducted on a spin-on glass substrate using only a press load and without applying ultrasonic vibrations, and the imprint surface was observed using an optical microscope. As a result, as with the polycarbonate and the polymethyl methacrylate, transfer patterns of the mold structures were not observed. Although the type of SOG used is different, Patent Document 3 discloses a case example in which a substrate heated only to a low temperature was pressed for 10 minutes at room temperature with a pressure of 25 kgf/cm². However, the method of the present invention succeeded in molding in one-tenth of the time required for the method of Patent Document 3 (i.e., in 1 minute), and furthermore, the applied load was small compared to that of Patent Document 3. In addition, the present invention is the first technology in the world to have succeeded in imprinting and transferring fine patterns at room temperature to an SOG surface after firing at a high temperature.

The successful transfer of fine patterns at room temperature onto a spin-on glass surface after firing can be seen as evidence that the range of materials that can be imprinted using the present invention is very broad. The method of the present invention can be broadly used not only for general-purpose engineering plastic but also for glass materials.

Optimum embodiments and experiments of the present invention have been presented above, but these examples were only presented to facilitate understanding of the present invention and were not presented for the purpose of limiting the scope of the present invention. For example, embodiments of the present invention include not only those that cool the molding material during pressing but also those that heat the molding material during pressing. Such embodiments are likely to be particularly useful for cases in which the glass-transition temperature of the molding material is very high. However, in the embodiments of the present invention, because there is no need to heat the molding material past the glass-transition temperature as in conventional cases, the advantage of being able to shorten the thermal cycle processes compared to conventional cases remains included.

Practical embodiments of the present invention are not limited to the above examples or to the examples identified in the scope of patent claims, and also include various new configurations that are explicitly and implicitly disclosed in the scope of patent claims, the specification, and the drawings as well as combinations thereof.

### INDUSTRIAL APPLICABILITY

The imprint technology according to the present invention is extremely useful for wiring for semiconductor devices exploiting the effects of preventing thermal transformation through room-temperature molding, or forming channels for biological and chemical analysis chips through imprinting in materials with high glass-transition temperatures, or as pit-forming technology for optical disks exploiting the high-speed performance of not including thermal cycle processes, for example. In particular, for multilayer wiring for semiconductor devices, it is sufficiently applicable to processes for adding layers at room temperature without destroying the wiring structures of lower layers produced in initial processes.

### EXPLANATION OF SYMBOLS

500: Imprint apparatus
501: upper-stage leveling apparatus
502: Pressurizer
503: Ultrasonic vibration generator
504: Upper stage
505: Mold-fixing unit
509: Molding-material and buffer-material fixing apparatus
510: Lower stage
512: Thermoregulator
521: Mold
522: Molding material
523: Buffer material
531: Controller

1. A nanoimprint apparatus configured to transfer fine patterns of a mold surface to a molding material by pressing said mold against said molding material or pressing said molding material against said mold while applying ultrasonic vibrations that propagate in the direction of application of a load, where:
said nanoimprint apparatus is configured to start an application of said ultrasonic vibrations and said load without heating said molding material to glass-transition temperature, and
a mechanism for applying said ultrasonic vibrations comprises a part for fixing said mold during at least the application of said ultrasonic vibrations.

2. The nanoimprint apparatus of claim 1, comprising a thermoregulator for cooling said molding material during the application of said ultrasonic vibrations.

3. The nanoimprint apparatus of claim 2, where said thermoregulator is operable to maintain a temperature of at least part of said molding material at room temperature during the application of said ultrasonic vibrations.

4. The nanoimprint apparatus of claim 1, configured to change at least one of the amplitude and frequency of said ultrasonic vibrations.

5. The nanoimprint apparatus of claim 1, configured to cause at least one of the amplitude and frequency of said ultrasonic vibrations being applied to become non-uniform within a surface on which said pressing is performed by using a plurality of ultrasonic vibration elements capable of changing at least one of the amplitude and the frequency, and operating at least one of these ultrasonic vibration elements at a different amplitude and/or frequency from the other elements.

6. A nanoimprint method for transferring fine patterns of a mold surface to a molding material by pressing said mold against said molding material or pressing said molding material against said mold while applying ultrasonic vibrations that propagate in the direction of application of a load, comprising:
starting an application of said ultrasonic vibrations and said load without heating said molding material to glass-transition temperature, and
during at least the application of said ultrasonic vibrations, fixing said mold to a mechanism for applying said ultrasonic vibrations.

7. The nanoimprint method of claim 6, comprising cooling said molding material for at least a predetermined period during the application of said ultrasonic vibrations.

8. The nanoimprint method of claim 6, where said molding material is fixed with a buffer material during at least the application of said ultrasonic vibrations.

9. A molded product manufactured through the method of claim 6.
